(19) United States
(12) Patent Application Publication
(10) Pub. No.: US 2011/0029849 A1
(43) Pub. Date: Feb. 3, 2011

(54) FILE BROWSER OUTPUT APPARATUS AND METHOD

(75) Inventors: Nam Wook Kang, Seoul (KR); Nirmal Patel, Atlanta, GA (US); Seung Eok Choi, Suwon-si (KR); In Sik Myung, Incheon Metropolitan City (KR); Sin Ae Kim, Suwon-si (KR); James Clawson, Atlanta, GA (US); Thad Starner, Atlanta, GA (US)

Correspondence Address: North Star Intellectual Property Law, PC, P.O. Box 34688, Washington, DC, 20043, US

(73) Assignees: SAMSUNG ELECTRONICS CO., LTD., Suwon-si (KR); GEORGIA TECH RESEARCH CORPORATION, Atlanta, GA (US)

(21) Appl. No.: 12/817,686

(22) Filed: Jun. 17, 2010

(30) Foreign Application Priority Data
Jul. 31, 2009 (KR) 10-2009-0070387

(51) Int. Cl. G06F 17/00; G06K 9/00

(52) U.S. Cl. 715/204; 382/118

(57) ABSTRACT

A file browser output apparatus and method that may display contents two-dimensionally are provided. The file browser output apparatus sets a retrieval object, sets an arrangement condition associated with a time in one of a horizontal axis and a vertical axis, and sets an arrangement condition unassociated with time in the other axis. The file browser output apparatus displays retrieval object contents based on the arrangement condition of the horizontal axis and the arrangement condition of the vertical axis.

### CROSS-REFERENCE TO RELATED APPLICATION(S)

This application claims the benefit under 35 U.S.C. §119(a) of Korean Patent Application No. 10-2009-0070387, filed on Jul. 31, 2009, in the Korean Intellectual Property Office, the entire disclosure of which is incorporated herein by reference for all purposes.

### BACKGROUND

1. Field

The following description relates to a file browser output apparatus and method, and particularly to, a file browser output apparatus and method that may arrange and output content two-dimensionally based on at least two arrangement conditions.

2. Description of Related Art

Current file browsers may arrange content based on a single arrangement condition, and output the arranged content based on the arrangement condition. For example, when content is images or photos, the images may be stored by a user and may be arranged in an ascending order or descending order based on an arrangement condition. For example, the arrangement condition may be the order in which the images were taken, a file name, and the like, and the arranged photographs may be outputted to a display.

The above described display scheme may be applicable in general output apparatuses such as a personal computer (PC), a mobile terminal, and the like.

In addition, media generated by mobile terminals that generate and display digital content are typically generated in a single device, and stored on the same device. However, due to the development of networks, such as wireless networks, WLAN, WiFi, WiMAX, and the like, mobile terminals may generate data and send data to other mobile terminals. For example, mobile terminals may utilize information such as extending operating time, location information using a global positioning system (GPS), a location and motion sensor, and the like, and send and receive this information with other devices connected on a network.

In an environment where content generated using the above described network are shared, problems arise in managing digital content, for example, image data, video data, voice data, and the like, generated by users, using an existing file browser.

Because existing file browsers arrange content based on a single arrangement condition, the content may need to be managed using a directory structure to classify the content. However, management using the directory structure may vary depending on to personal taste, and thus it can be difficult to understand directories generated by other users. Also, when the content managed using the directory structure are classified using another classification basis, a new directory may need to be created and content may need to be re-classified.

### SUMMARY

In one general aspect, provided is a file browser output apparatus, comprising an interface unit to set a retrieval object content, to set an arrangement condition associated with time in a first axis that is either a vertical axis or a horizontal axis, and to set an arrangement condition unassociated with time in a second axis that is different from the first axis, a control unit to verify the retrieval object content to be retrieved, and to verify information corresponding to an arrangement condition of the horizontal axis and an arrangement condition of the vertical axis, from among the retrieval object content, and a display configuration unit to display the retrieval object content based on the arrangement condition of the horizontal axis and the arrangement condition of the vertical axis.

The control unit may include a metadata verification unit to verify the information corresponding to the arrangement condition of the horizontal axis or the arrangement condition of the vertical axis, based on at least one of a storage location of usable content, a content type, a writer of the content, a rights condition of the content, a usage condition of the content, and a usage history of the content.

The control unit may include a picture photographing information verification unit to verify the information corresponding to the arrangement condition of the horizontal axis or the arrangement condition of the vertical axis in an exchangeable image file format (Exif), based on usable information available when the retrieval object content is photographs.

The control unit may include a log processing unit to verify the information corresponding to the arrangement condition of the horizontal axis or the arrangement condition of the vertical axis in log data, based on at least one of an initial verification time of the content, an update time of the content, and a storage time of the content.

The control unit may include a face sensing unit to verify a face of a person included in a photograph, to identify the person, and to provide the identified person as the information corresponding to the arrangement condition of the horizontal axis or the arrangement condition of the vertical axis.

The control unit may include a face sensing unit to count a number of persons included in a photograph, and provide the number counted as the information corresponding to the arrangement condition of the horizontal axis or the arrangement condition of the vertical axis.

The interface unit may be set such that the at least one arrangement condition associated with time is the arrangement condition of the horizontal axis.

The interface unit may set the arrangement condition of the vertical axis as a writer of the content, and set the arrangement condition of the horizontal axis as the arrangement condition associated with time.

The arrangement condition associated with time may be at least one of a generation time of the content, an initial verification time of the content, an update time of the content, and a storage time of the content.

The arrangement condition unassociated with time may be at least one of a storage location of the content, a content type, a writer information of the content, a rights condition of the content, a usage condition of the content, a usage history of the content, and information included in an exchangeable image file format.

The interface unit may respectively set at least one arrangement condition in the horizontal axis and in the vertical axis.

In another aspect, provides is a file browser method to output a two-dimensional display, the method comprising setting retrieval object content, setting an arrangement condition associated with time in a first axis that is either a vertical axis or a horizontal axis, and setting an arrangement condition unassociated with the time in a second axis that is different from the first axis, verifying the retrieval object content to be retrieved from among stored content, verifying information corresponding to an arrangement condition of the horizontal axis and an arrangement condition of the vertical axis, from among the retrieval object content, and displaying the retrieval object content based on the arrangement condition of the horizontal axis and the arrangement condition of the vertical axis.

The verifying of the information may verify the information corresponding to the arrangement condition of the horizontal axis or the arrangement condition of the vertical axis in metadata, based on at least one of a storage location of usable content, a content type, a writer information of the content, a rights condition of the content, a usage condition of the content, and a usage history of the content.

The verifying of the information may verify the information corresponding to the arrangement condition of the horizontal axis or the arrangement condition of the vertical axis in an exchangeable image file format, based on usable information available when the retrieval object content is photographs.

The verifying of the information may verify the information corresponding to the arrangement condition of the horizontal axis or the arrangement condition of the vertical axis in log data, based on at least one of an initial verification time of the content, an update time of the content, and a storage time of the content.

The verifying of the information may verify a face of a person included in a photograph, identifies the person, and provides the identified person as the information corresponding to the arrangement condition of the horizontal axis or the arrangement condition of the vertical axis.

The verifying of the information may count a number of persons included in a photograph, and provides the number counted as the information corresponding to the arrangement condition of the horizontal axis or the arrangement condition of the vertical axis.

The setting of the arrangement condition may be set such that the at least one arrangement condition associated with time is the arrangement condition of the horizontal axis.

The setting of the arrangement condition may set the arrangement condition of the vertical axis as a writer of the content, and sets the arrangement condition of the horizontal axis as the arrangement condition associated with time.

The arrangement condition associated with time may be at least one of a generation time of the content, an initial verification time of the content, an update time of the content, and a storage time of the content.

The arrangement condition unassociated with time may be at least one of a storage location of the content, a content type, a writer of the content, a rights condition of the content, a usage condition of the content, a usage history of the content, and information included in an exchangeable image file format.

The setting of the arrangement condition may respectively set at least one arrangement condition in the horizontal axis and in the vertical axis.

Other features and aspects will be apparent from the following detailed description, the drawings, and the claims.

### BRIEF DESCRIPTION OF THE DRAWINGS

FIG. 1 is a diagram illustrating an example of a file browser output apparatus.

FIG. 2 is a graph illustrating an example of photographs arranged two-dimensionally.

FIG. 3 is a flowchart illustrating an example of a method for arranging and to outputting content two-dimensionally.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

Example illustrations relate to a file browser output apparatus and method that may arrange content two-dimensionally based on at least two arrangement conditions. The file browser out apparatus and method may be used to configure a display based on the at least two arrangement conditions

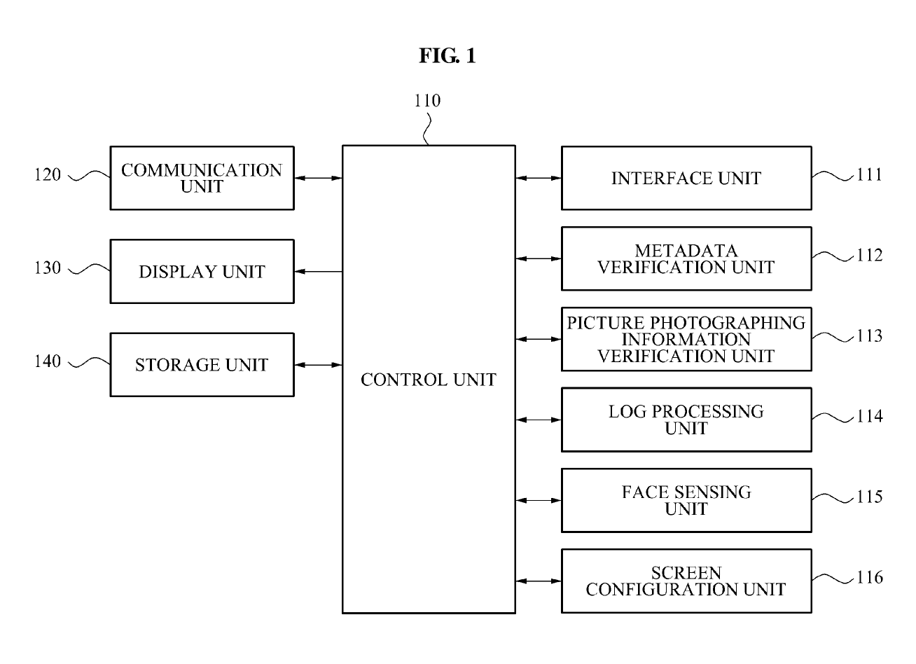

FIG. 1 illustrates a file browser output apparatus that may arrange content two-dimensionally. The content may be displayed based on at least two arrangement conditions, and the at least two arrangement conditions may be used to configure a display.

The example file browser output apparatus shown in FIG. 1 includes a control unit 110, an interface unit 111, a metadata verification unit 112, a picture photographing information verification unit 113, a log processing unit 114, a face sensing unit 115, a display configuration unit 116, a communication unit 120, a display unit 130, and a storage unit 140.

The communication unit 120 may transmit/receive content through wired/wireless communication.

The display unit 130 may output state information (or indicator) generated during operation of the file browser output apparatus, and may display a two-dimensional (2D) display configured by the display configuration unit 116. The display unit 130 may use a display, for example, a Liquid Crystal Display (LCD) device, a light emitting diode (LED), and organic light emitting diode (OLED), a plasma display, and the like.

The storage unit 140 may store various types of content, and store log data of the stored contents. The storage unit 140 may be shared through the communication unit 120.

The metadata verification unit 112 may retrieve usable information as an arrangement condition included in the metadata. The metadata of the content may include, for example, a storage location of content, a content type, a writer of content, a right condition of content, a usage condition of content, a usage history of content, and the like.

The picture photographing information verification unit 113 may retrieve usable information as an arrangement condition included in an exchangeable image file format (Exif). The Exif may include detailed additional information, for example, a camera maker, a camera model, an image editor of a software, a photograph correction date, an Exif version, a photographing date, a photograph size, an exposure time or a shutter speed, a photographing program, a focal length of lens, an aperture opening numerical value (F-number), whether a flash is used, and the like. The Exif may include location information using a global positioning system (GPS).

The log processing unit 114 may retrieve usable information as an arrangement condition included in log data. The log data of content may include, for example, an initial verification time, an update time, and a storage time.

The face sensing unit 115 may verify, for example, that the retrieval object content is photographs, a face of a person included in a photograph, identify the person, and provide the identified person as the arrangement condition. For example, the face sensing unit 115 may count a number of persons included in the photograph, and provide the counted number as the arrangement condition.

The interface unit 111 may set a retrieval object and/or different arrangement conditions in a horizontal axis and a vertical axis, used for configuring a 2D display. The interface unit 111 may set a retrieval object using an input of a user. The interface unit 111 may set the retrieval object and the arrangement condition based on a predetermined setting when the input of the user is not used. The interface unit 111 may set at least one arrangement condition in each of the horizontal axis and the vertical axis.

The interface unit 111 may be set to have at least one of the arrangement conditions associated with time as an arrangement condition of the vertical axis. For example, the arrangement conditions of the content may be associated with a time, for example, a generation time, an initial verification time of content, an update time of content, a storage time of content, and the like.

The display configuration unit 116 may arrange the retrieval object content based on the arrangement condition of the horizontal axis and the arrangement condition of the vertical axis. The display unit 130 may be used to configure the 2D display using the horizontal axis and the vertical axis, and output the configured 2D display using the display unit 130.

The control unit 110 may control general operations of the file browser output apparatus. For example, the control unit 110 may control one or more of the interface unit 111, the metadata verification unit 112, the picture photographing information verification unit 113, the log processing unit 114, the face sensing unit 115, and the display configuration unit 116. In some embodiments, the control unit 110 may perform functions of one or more of the interface unit 111, the metadata verification unit 112, the picture photographing information verification unit 113, the log processing unit 114, the face sensing unit 115, and/or the display configuration unit 116. For the purpose of example, the above-described units controlled by the control unit 110 are separately configured to classify and describe the above described functions. However, in some embodiments, one or more of the above-described units may be incorporated into the same unit. Also, when embodying the file browser output apparatus, one or more of the above-described units may be configured to be controlled in the control unit 110, or a part thereof may be configured to be controlled in the control unit 110.

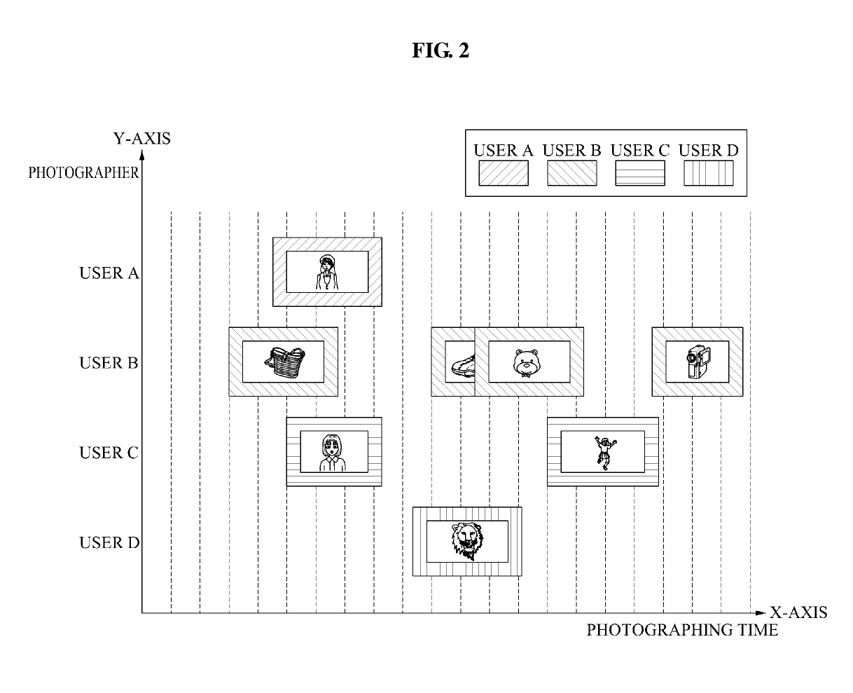

An example of an output of a file browser that may configure content in a 2D display and output the configured content will be described with reference to FIG. 2.

FIG. 2 illustrates an example of photographs arranged two-dimensionally. The photographs may be arranged on display based on a plurality of users relative to time. The display may be configured to output the photographs to the display based upon when the photographs were taken and by which user.

As shown in FIG. 2, a photographing time may be set as the arrangement condition of the horizontal axis and a user may be set as the arrangement condition of the vertical axis. The arrangement conditions are used to display or arrange content of the photographs on the display. In this example, photographs taken by each photographer may be chronologically verified. For example, an edition such as a chronological configuration may be performed when the arrangement condition is set as in FIG. 2.

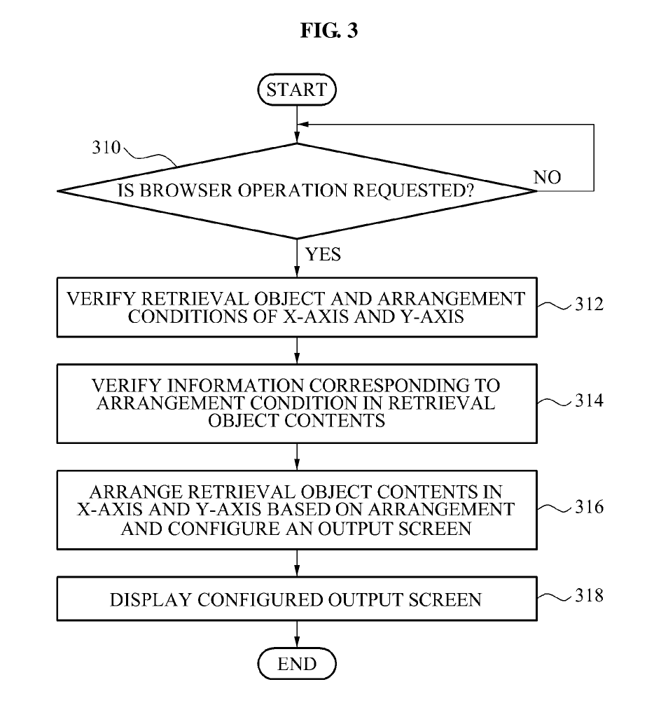

A method of arranging content two-dimensionally based on at least two arrangement conditions, configuring a display, and outputting the display in the file browser output apparatus configured as described above will be described with reference to FIG. 3.

FIG. 3 illustrates an example of a method for arranging content two-dimensionally. The content may be arranged based on at least two arrangement conditions, and configured by a file browser output apparatus.

As shown in FIG. 3, when receiving a request for operation of a file browser in operation 310, an example file browser output apparatus may proceed to operation 312, and set different arrangement conditions in each of a horizontal axis and a vertical axis which are used for configuring a 2D display. At least one arrangement condition may be set in each of the horizontal axis and the vertical axis. For example, a first arrangement condition associated with a time may be set as an arrangement condition of the horizontal axis, and a user may be set as a first arrangement condition of the vertical axis. The arrangement conditions of the content associated with the time may be a generation time of content, an initial verification time of content, an update time of content, a storage time of content, and the like.

The arrangement conditions may include, for example, the information of metadata, the information of Exif, and/or the information of the log data. For example, when the content is photographs, the information about the number of photographs and the person may be selected as the arrangement conditions.

In operation 314, the file browser output apparatus may verify information corresponding to the arrangement condition of the horizontal axis and the arrangement condition of the vertical axis from among retrieval object content. Information of metadata, information of Exif, and information of the log data may be used for the arrangement conditions. For example, when the content is photographs, the information about the number of photographs and the person taking the photographs may be used as the arrangement conditions.

In operation 316, the file browser output apparatus may horizontally and vertically arrange the retrieval object content based on the arrangement conditions, configure a 2D display, proceed to operation 318, and display the configured 2D display.

As described above, provided is a file browser output apparatus and method that may arrange content two-dimensionally based on at least two arrangement conditions and configure a display, and thereby allow a user to retrieve and verify content through a 2D display configuration.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. The media and program instructions may be those specially designed and constructed, or they may be of the kind well-known and available to those having skill in the computer software arts. Examples of computer-readable storage media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A file browser output apparatus, comprising:
an interface unit configured to:
set a retrieval object content;
to set an arrangement condition associated with time in a first axis that is either a vertical axis or a horizontal axis; and
to set an arrangement condition unassociated with time in a second axis that is different from the first axis;
a control unit configured to:
verify the retrieval object content to be retrieved; and
verify information corresponding to an arrangement condition of the horizontal axis and an arrangement condition of the vertical axis, from among the retrieval object content; and
a display configuration unit configured to display the retrieval object content based on the arrangement condition of the horizontal axis and the arrangement condition of the vertical axis.

2. The file browser output apparatus of claim 1, wherein the control unit comprises a metadata verification unit to verify the information corresponding to the arrangement condition of the horizontal axis or the arrangement condition of the vertical axis, based on at least one of a storage location of usable content, a content type, a writer of the content, a rights condition of the content, a usage condition of the content, and a usage history of the content.

3. The file browser output apparatus of claim 1, wherein the control unit comprises a picture photographing information verification unit configured to verify the information corresponding to the arrangement condition of the horizontal axis or the arrangement condition of the vertical axis in an exchangeable image file format (Exif), based on usable information available when the retrieval object content is photographs.

4. The file browser output apparatus of claim 1, wherein the control unit comprises a log processing unit configured to verify the information corresponding to the arrangement condition of the horizontal axis or the arrangement condition of the vertical axis in log data, based on at least one of: an initial verification time of the content, an update time of the content, and a storage time of the content.

5. The file browser output apparatus of claim 1, wherein the control unit comprises a face sensing unit configured to:
verify a face of a person included in a photograph;
identify the person; and
provide the identified person as the information corresponding to the arrangement condition of the horizontal axis or the arrangement condition of the vertical axis.

6. The file browser output apparatus of claim 1, wherein the control unit comprises a face sensing unit configured to:
count a number of persons included in a photograph; and
provide the number counted as the information corresponding to the arrangement condition of the horizontal axis or the arrangement condition of the vertical axis.

7. The file browser output apparatus of claim 1, wherein the interface unit is configured to be set such that the at least one arrangement condition associated with time is the arrangement condition of the horizontal axis.

8. The file browser output apparatus of claim 1, wherein the interface unit is further configured to:
set the arrangement condition of the vertical axis as a writer of the content; and
set the arrangement condition of the horizontal axis as the arrangement condition associated with time.

9. The file browser output apparatus of claim 1, wherein the arrangement condition associated with time comprises at least one of: a generation time of the content, an initial verification time of the content, an update time of the content, and a storage time of the content.

10. The file browser output apparatus of claim 1, wherein the arrangement condition unassociated with time comprises at least one of: a storage location of the content, a content type, a writer information of the content, a rights condition of the content, a usage condition of the content, a usage history of the content, and information included in an exchangeable image file format.

11. The file browser output apparatus of claim 1, wherein the interface unit is further configured to respectively set at least one arrangement condition in the horizontal axis and in the vertical axis.

12. A file browser method to output a two-dimensional display, the method comprising:
setting retrieval object content;
setting an arrangement condition associated with time in a first axis that is either a vertical axis or a horizontal axis;
setting an arrangement condition unassociated with the time in a second axis that is different from the first axis;
verifying the retrieval object content to be retrieved from among stored content;
verifying information corresponding to an arrangement condition of the horizontal axis and an arrangement condition of the vertical axis, from among the retrieval object content; and
displaying the retrieval object content based on the arrangement condition of the horizontal axis and the arrangement condition of the vertical axis.

13. The file browser method of claim 12, wherein the verifying of the information comprises verifying the information corresponding to the arrangement condition of the horizontal axis or the arrangement condition of the vertical axis in metadata, based on at least one of: a storage location of usable content, a content type, a writer information of the content, a rights condition of the content, a usage condition of the content, and a usage history of the content.

14. The file browser method of claim 12, wherein the verifying of the information comprises verifying the information corresponding to the arrangement condition of the horizontal axis or the arrangement condition of the vertical axis in an exchangeable image file format, based on usable information available when the retrieval object content is photographs.

15. The file browser method of claim 12, wherein the verifying of the information comprises verifying the information corresponding to the arrangement condition of the horizontal axis or the arrangement condition of the vertical axis in log data, based on at least one of an initial verification time of the content, an update time of the content, and a storage time of the content.

16. The file browser method of claim 12, wherein the verifying of the information comprises:
verifying a face of a person included in a photograph;
identifying the person; and
providing the identified person as the information corresponding to the arrangement condition of the horizontal axis or the arrangement condition of the vertical axis.

17. The file browser method of claim 12, wherein the verifying of the information comprises:
counting a number of persons included in a photograph; and
providing the number counted as the information corresponding to the arrangement condition of the horizontal axis or the arrangement condition of the vertical axis.

18. The file browser method of claim 12, wherein the setting of the arrangement condition comprises setting such that the at least one arrangement condition associated with time is the arrangement condition of the horizontal axis.

19. The file browser method of claim 12, wherein the setting of the arrangement condition comprises setting the arrangement condition of the vertical axis as a writer of the content, and sets the arrangement condition of the horizontal axis as the arrangement condition associated with time.

20. The file browser method of claim 12, wherein the arrangement condition associated with time comprises at least one of: a generation time of the content, an initial verification time of the content, an update time of the content, and a storage time of the content.

21. The file browser method of claim 12, wherein the arrangement condition unassociated with time comprises at least one of: a storage location of the content, a content type, a writer of the content, a rights condition of the content, a usage condition of the content, a usage history of the content, and information included in an exchangeable image file format.

22. The file browser method of claim 12, wherein the setting of the arrangement condition comprises respectively setting at least one arrangement condition in the horizontal axis and in the vertical axis.
